(19) United States
(12) Patent Application Publication
(10) Pub. No.: US 2017/0364996 A1
(43) Pub. Date: Dec. 21, 2017

(54) METHOD AND SYSTEM FOR FACILITATING AND ENABLING CROWDSOURCED CREDIT COLLECTION

(71) Applicants: Pietro VENTANI, Singapore (SG); Charles Hugues Max CROUSPEYRE, Singapore (SG)

(72) Inventors: Pietro VENTANI, Singapore (SG); Charles Hugues Max CROUSPEYRE, Singapore (SG)

(21) Appl. No.: 15/183,397

(22) Filed: Jun. 15, 2016

(51) Int. Cl. G06Q 40/02; G06Q 50/00; G01S 19/13

(52) U.S. Cl. CPC G06Q 40/02; G01S 19/13; G06Q 50/01

(57) ABSTRACT

The present disclosure described herein, in general, relates to computer-based platform for facilitating and/or enabling the crowdsourced credit collection. The platform facilitates credit collection by assigning a crowdsourced user in same areas, based on the geolocation of the borrower. The system comprises a credit collection request module, a location module, a training module, a user selection module and a payment module. The credit collection request module is configured to receive the credit collection request to collect the credit due from the borrower. The location module is configured to determine the borrower's geolocation as-well-as the geolocation of the user. The user selection module is configured to identify one or more registered users, present within the predefined range of the borrower's geolocation. Further, the user selection module is configured to select a user from one or more registered users based on predefined parameters associated with each user. The payment module is configured to process the credit collection as-well-as enable remittance of the user payment after successful credit collection.

### CROSS-REFERENCE TO RELATED APPLICATIONS AND PRIORITY

The present application does not claim priority from any patent application.

### TECHNICAL FIELD

The present disclosure described herein, in general, relates to a method and system for facilitating and/or enabling and/or making economically feasible the collection of credit collection through a network of users on a computer-based platform.

### BACKGROUND

Financial institutions/credit lenders provide lending and credit services to individual borrowers. The financial institutes/credit lenders would typically assess the cost associated with the credit collection process in order to determine the probability to collect the credit from the borrowers. The assessment may either be positive or negative. If the assessment is positive, the financial institute/credit lender may proceed with the credit collection whereas if the assessment is negative, the financial institute/credit lender may write-off the credit. Typically, the assessment may include the cost/benefit analysis where all fix costs associated with the collection case (management time, collection agent fix costs etc.) are compared against the amount due to collect weighted for the probability to collect (“expected amount”). If the fixed costs exceed a certain ratio to the expected amount, the lender would typically write off the credit. A very significant amount of loans, especially in the micro credit category are written off because of the projected collection costs exceed the amount to be collected. For the same reason many lenders decline the lending of micro amounts as they would be, by definition, too small to afford a collection effort.

In case the assessment is positive and a decision is made to collect the credit from the borrower, the lender may assign a collection party for the collection. The collection party is assigned from the list of collection parties (“Agent”) who are already associated with the said lenders. The assigning of the Agent is generally done, mostly based on the various parameters such as performance, charges/cost of Agent.

In the existing art, various computer enabled systems are provided that manages the credit collection process on behalf of the lenders giving credits to the individual borrowers or entities. These systems typically assign credit collection parties for the credit collection process based on the past performance of the Agent. However, the performance based assignment may not be feasible as the Agent may not find exact location of the credit borrower default on payment thereby impeding the credit payment. Another reason that impedes the collection is the location of the borrower. When the Agent makes on-site visits (not common due to costs), he/she tend to optimize their fees/schedule and, therefore, will tend to neglect areas that are too distant and/or sparsely populated.

Additionally, the Agent may not have a convenient time for collection of the payment relative to the location of the borrower. Further, there are possibilities of delay in the case, if the Agent is far from the location of the borrower. Further, since the systems assigns the Agent already associated with the financial institutes/Lender, an interested party willing to collect the payment and located nearby to the location of the borrower may be missed from assignment even if he/she is close to the borrower's location. Furthermore, the effectiveness of the collection effort is, by definition, the outcome of the ability of the Agent to interface with the borrower. Hence in case of a substantial difference between language/dialect and/or culture of the Agent and borrower, the effectiveness of the collection may be impaired and lead to failure in successful completion of the credit collection process.

### SUMMARY

This summary is provided to introduce concepts related to systems and methods for facilitating, and enabling and making economically feasible the collection of credits that would otherwise need to be written off and charged off by the bank/lender. Further, the aforementioned systems and methods enable the lending of micro amounts that are typically avoided by Financial institutions/credit lenders. The crowdsourced credit collection and the concepts are further described below in the detailed description. This summary is not intended to identify essential features of the claimed subject matter nor is it intended for use in determining or limiting the scope of the claimed subject matter.

In one implementation, a method for facilitating and/or enabling and/or making economically viable the crowdsourced credit collection on a computer-based platform is disclosed. The method may comprise receiving, by a processor, a credit collection request for collecting a credit due from a borrower. The credit collection request may comprise borrower details comprising at least a borrower's geolocation. The method may further comprise identifying, by the processor, one or more registered users having a geolocation within a predefined range of the borrower's geolocation. The method may further comprise selecting, by the processor, a user from the one or more registered users based on predefined parameters associated with each user. The predefined parameters comprise at least one of a load of credit collection requests assigned to each user, nearest location of each user with respect to the borrower's geolocation, reputation of each user (efficiency of establishing a contact, efficiency of recovering the money quickly, efficiency of working with tiers/party), language, culture and a combination thereof. The method may further comprise authorizing, by the processor, the user to collect the credit due from the borrower based on a predefined credit collection process. The method may further provide geographic map tools on a user device associated with the user in order to navigate to the borrower's geolocation for the credit collection. It is to be noted that each user is trained for the predefined credit collection process via a pre-stored training module comprising training content associated with the predefined credit collection process.

In another implementation, a system for facilitating and/or enabling crowdsourced credit collection is described. The system may comprise a processor and a memory coupled with the processor. The processor is capable of executing programmed instructions stored in the memory. The processor may execute a programmed instruction for receiving a credit collection request for collecting a credit due from a borrower. The credit collection request may comprise borrower details comprising at least a borrower's geolocation. The processor may further execute a programmed instruction for identifying one or more registered users, having geolocation within a predefined range of the borrower's geolocation. The processor may further execute a programmed instruction for selecting a user from the one or more registered users based on predefined parameters associated with each user. The predefined parameters comprise at least one of a load of credit collection requests assigned to each user, nearest location of each user with respect to the borrower's geolocation, reputation of each user (efficiency of establishing a contact, efficiency of recovering the money quickly, efficiency of working with tiers/party), language, culture and a combination thereof. The processor may further execute a programmed instruction for authorizing the user to collect the credit due from the borrower based on a predefined credit collection process. The processor may further execute a programmed instruction to provide geographic map tools on a user device associated with the user in order to navigate to the borrower's geolocation for the credit collection. It is to be noted that each user is trained for the predefined credit collection process via a pre-stored training module comprising training content associated with the predefined credit collection process.

In yet another implementation, a non-transitory computer readable medium storing a program for facilitating and/or enabling crowdsourced credit collection is described. The program may comprise a program code for receiving a credit collection request for collecting a credit due from a borrower. The credit collection request may comprise borrower details comprising at least a borrower's geolocation. The program may further comprise a program code for identifying one or more registered users having a geolocation within a predefined range of the borrower's geolocation. The program may further comprise selecting a user from one or more registered users based on predefined parameters associated with each user. The predefined parameters comprise at least one of load of credit collection requests assigned to each user, nearest location of each user with respect to the borrower's geolocation, reputation of each user (efficiency of establishing a contact, efficiency of recovering the money quickly, efficiency of working with tiers/party), language, culture and a combination thereof. The program may further comprise a program code for authorizing the user to collect the credit due from the borrower based on a predefined credit collection process. The program may further comprise a program code for providing geographic map tools on a user device associated with the user in order to navigate to the borrower's geolocation for the credit collection. It is to be noted that each user is trained for the predefined credit collection process via a pre-stored training module comprising training content associated with the predefined credit collection process.

The present disclosure facilitates and enables the collection wherever located, even in remote areas. By abating fixed costs through technology, the present disclosure essentially enables the collection of very small amounts, also enabling microcredit.

### BRIEF DESCRIPTION OF THE DRAWINGS

The detailed description is described with reference to the accompanying figures. In the figures, the left-most digit(s) of a reference number identifies the figure in which the reference number first appears. The same numbers are used throughout the drawings to refer like features and components.

FIG. 1 illustrates a network implementation of a system 101 facilitating and/or enabling the crowdsourced credit collection, in accordance with an embodiment of the present disclosure.

FIG. 2 illustrates the system 101, in accordance with an embodiment of the present disclosure.

FIG. 3 shows the working of the system 101 along with the modules of the system, in accordance with an embodiment of the present disclosure.

FIG. 4 illustrates a method 400 facilitating and enabling the crowdsourced credit collection, in accordance with an embodiment of the present disclosure.

### DETAILED DESCRIPTION

The present disclosure relates to method(s) and system(s) for facilitating and/or enabling crowdsourced credit collection on a computer-based platform. In accordance with aspects of the present disclosure, a credit collection user is assigned for collecting a credit due from a borrower based on the borrower's geolocation. The borrower's geolocation is either captured by a back end server associated to a lending party using a global positioning system (GPS) technique or by converting the physical address, of the borrower, into latitude/longitude coordinates using various geographical map tools known in the art. In accordance with the aspects of the present disclosure, a credit collection request for collecting a credit due from the borrower may be received. The credit collection request comprises the borrower's geolocation and additional borrower details including, but not limited to, one of the borrower's name, residence address, workplace address, account statement, credit history and a combination thereof.

After receiving the request, one or more registered users may be identified having a geolocation within the predefined range of the borrower's geolocation. The geolocation of each registered user may be determined using a GPS technique. Further, each user is trained for a predefined credit collection process via a pre-stored training module comprising training content associated with the credit collection process.

After the identification of one or more registered users, a user may be selected based on predefined parameters associated with each user, for facilitating the credit collection process. The user may be selected based on predefined parameters including, but not limited to, load of credit collection requests assigned to each user, nearest location of each user with respect to the borrower geolocation, reputation of each user (efficiency of establishing a contact, efficiency of recovering the money quickly, efficiency of working with tiers/party), language, culture and a combination thereof.

Subsequent to the selection of the user, the user is authorized to collect the credit based on the predefined credit collection process. The borrower may be enabled to process the payment for the credit using an online payment system or an offline system. The user is allowed to remit payment after the successful collection of the credit due from the borrower. In accordance with the aspects of the present disclosure, the computer based system(s) and method(s) facilitates in automatic repayment to the lender/financial institution as-well-as remit the payment of the user after the successful repayment to the lender/financial institution.

While aspects of described system and method for facilitating and enabling the crowdsourced credit collection may be implemented in any number of different computing systems, environments, and/or configurations, the embodiments are described in the context of the following exemplary system.

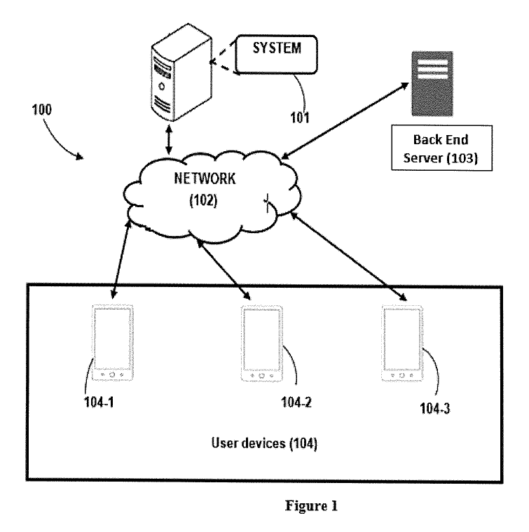

Referring now to FIG. 1, a network implementation 100 of a system 101 for facilitating and enabling the crowdsourced credit collection is illustrated, in accordance with an implementation of the present disclosure. In an embodiment, the system 101 may receive a credit collection request for collecting a credit due from a borrower through a network 102. The credit collection request may comprise at least a borrower's geolocation. The system 101 may further identify one or more registered users, having geolocation within a predefined range of the borrower's geolocation. The system 101 may further select a user from one or more registered users based on predefined parameters associated with each user. The predefined parameters comprise at least one of load of credit collection requests assigned to each user, nearest location of each user with respect to the borrower's geolocation, reputation of each user (efficiency of establishing a contact, efficiency of recovering the money quickly, efficiency of working with tiers/party), language, culture and a combination thereof. After the selection of the user, the user may be authorized for collecting the credit from the borrower based on the credit collection process. The system 101 may provide geographic map tools on a user device associated with the user in order to navigate to the borrower's geolocation for the credit collection. It must be noted that each user is trained for the credit collection process via a training module comprising training content associated with the credit collection process.

The geolocation of the borrower may be retrieved from a back end server 103. The back end server 103 may provide the borrower's details comprising the borrower's geolocation and at least one of the borrower's full name, address, identity proof, outstanding amount, power of attorney and a combination thereof to the system 101. Further, the back end server 103 may further provide one or more geographical map tools enabling to navigate to the borrower's geolocation. The back end server 103 is synchronized with the system 101, in a manner such that, the borrower's details as-well-as the one or more geographical tools may be displayed to the user via the user device 104. The system 101 may further provide a power of authorization and a legal framework on the user device of the user 104 for the credit collection process.

Although the present disclosure is explained considering that the system 101 is implemented on a server, it may be understood that the system 101 may also be implemented in a variety of computing systems, such as a laptop computer, a desktop computer, a notebook, a workstation, a mainframe computer, a server, a network server, and the like. It will be understood that the system 101 may be accessed by multiple users through one or more user devices 104-1, 104-2 . . . 104-N, collectively referred to as user 104 hereinafter, or applications residing on the user devices 104. Examples of the user devices 104 may include, but are not limited to, a portable computer, a personal digital assistant, a handheld device, and a workstation. The user devices 104 are communicatively coupled to the system 101 through a network 102.

In one embodiment, the network 102 may be a wireless network, a wired network or a combination thereof. The network 102 can be implemented as one of the different types of networks, such as intranet, local area network (LAN), wide area network (WAN), the internet, and the like. The network 102 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 102 may include a variety of network devices, including routers, bridges, servers, computing devices, storage devices, and the like.

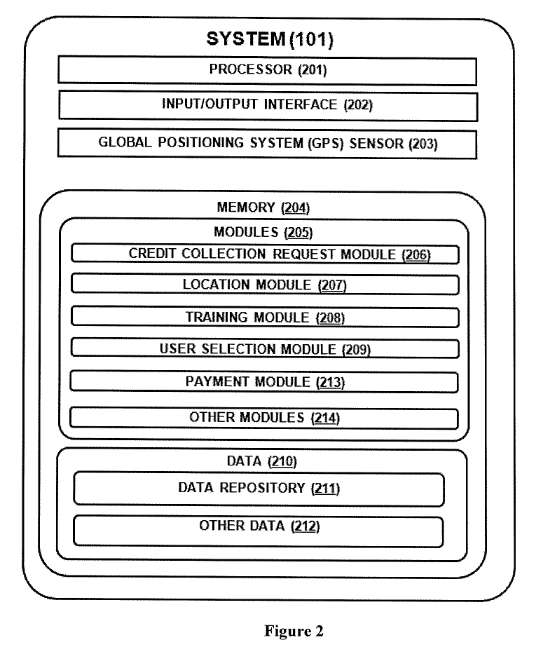

Referring now to FIG. 2, the system 101 is illustrated in accordance with an embodiment of the present subject matter. In one embodiment, the system 101 may include at least one processor 201, an input/output (I/O) interface 202, a GPS sensor 203 and a memory 204. The at least one processor 201 may be implemented as one or more microprocessors, microcomputers, microcontrollers, digital signal processors, central processing units, state machines, logic circuitries, and/or any devices that manipulate signals based on operational instructions. Among other capabilities, the at least one processor 201 is configured to fetch and execute computer-readable instructions stored in the memory 204.

The I/O interface 202 may include a variety of software and hardware interfaces, for example, a web interface, a graphical user interface, and the like. The I/O interface 202 may allow the system 101 to interact with a user directly or through the user devices 104. Further, the I/O interface 202 may enable the system 101 to communicate with other computing devices, such as web servers and external data servers (not shown). The I/O interface 202 can facilitate multiple communications within a wide variety of networks and protocol types, including wired networks, for example, LAN, cable, etc., and wireless networks, such as WLAN, cellular, or satellite. The I/O interface 202 may include one or more ports for connecting a number of devices to one another or to another server.

The GPS sensor 203 as illustrated in FIG. 2 may be configured to detect the geolocation of the user 104. The GPS sensor 203 can facilitate multiple communications within a wide variety of networks and protocol types, including wired networks, for example, LAN, cable, etc., and wireless networks, such as WLAN, cellular, or satellite.

The memory 204 may include any computer-readable medium known in the art including, for example, volatile memory, such as static random access memory (SRAM) and dynamic random access memory (DRAM), and/or non-volatile memory, such as read only memory (ROM), erasable programmable ROM, flash memories, hard disks, optical disks, and magnetic tapes. The memory 204 may include modules 205 and data 210.

The modules 205 include routines, programs, objects, components, data structures, etc., which perform particular tasks or implement particular abstract data types. In one implementation, the modules 205 may include a credit collection request module 206, a location module 207, a training module 208, a user selection module 209, a payment module 213 and other modules 214. The other modules 214 may include programs or coded instructions that supplement applications and functions of the system 101.

The data 210, amongst other things, serves as a repository for storing data processed, received, and generated by one or more of the modules 208. The data 210 may also include a data repository 211 and other data 212. The user profiles, geolocation of user, training data for credit collection and back end server data may be stored in the data repository 211. The other data 212 may include data generated as a result of the execution of one or more modules in the other module 214.

In one embodiment, at first, a user may use the user device 104 to access the system 101 via the I/O interface 202. The user may register themselves using the I/O interface 204 in order to use the system 101. Based on the registration, a user profile comprising the details of the user provided by user 104 may be received by the system 101. The user profile comprises user's geolocation and at least one of user's name, age, sex, photo, identity proof and a combination thereof. By providing the details by the user 104, the account for the user is generated and registered with the system 101. Furthermore, the user id and the password may be generated for the logging into the system 101.

The working of the system 101 may be explained in detail referring to FIGS. 2 & 3 as below. The system 101 may be used for facilitating and enabling the crowdsourced credit collection from the borrower. In order to assign the user for credit collection, the system 101, at first, receives the credit collection request to collect the credit due from the borrower. Specifically, in an embodiment, the credit collection request module 206 may be configured to receive the credit collection request from the back end server 103. The credit collection request may be received in order to initiate credit collection from the borrower. The credit collection request may comprise borrower's details comprising borrower's geolocation and at least one of the borrower's full name, address, identity proof, outstanding amount, power of attorney and a combination thereof.

In an embodiment, the back end server 103 may capture the borrower's geolocation using the GPS technique through a GPS sensor present within the back end server. Alternatively, the back end server may send physical address of the borrower in the borrower details received by the system 101. The location module 207 in the system 101 may be configured to convert the physical address into a latitude/longitude coordinates using geographical maps tools known in the art thereby determining the borrower's location. The location module 207 may be further configured to determine the geolocation of the user 104. The location of the user 104 may be determined with the help of GPS sensor 203.

The training module 208 may be configured to provide training for the credit collection process on the user 104. Multiple trainings sessions may be provided to the user 104. The user has to go through all the training sessions to be an authorized user for credit collection from the borrower.

The user selection module 209 may be configured to identify one or more registered users 104, present within the predefined range of the borrower's geolocation. The location of each user may be determined via GPS sensor 203. Further, the user selection module 209 may be configured to select a user 104 from one or more registered users based on predefined parameters associated with each user. The predefined parameters comprise at least one of load of credit collection requests assigned to each user, nearest location of each user with respect to the borrower's geolocation, reputation of each user (efficiency of establishing a contact, efficiency of recovering the money quickly, efficiency of working with tiers/party), language, culture and a combination thereof. It must be understood that the credit collection is based on the ability of the user to effectively communicate with the borrower and, in essence to persuade the borrower to settle the debit. Therefore, the parameters such as the language and the culture plays a vital role in the persuading the borrower. In one example, say a user from US, speaking English collecting in Spain from a Spanish speaker borrower is, not as effective as a Spanish speaking user. Therefore, in this example, the system 101 may automatically select a user acquainted with the Spanish language and assigned the said user in order to collect the credit due from the Spanish speaker borrower. Particularly, the above capability of the system 101 to assign the user based on the language and the culture is more effective in large countries such as Mexico, Brazil, Bangladesh, India and Pakistan having diverse languages and cultures. Further, the user selection module 209 may be configured to authorize the user 104 to collect the credit due from the borrower based on a predefined credit collection process.

The payment module 213 may be configured to process the credit collection using an online or offline payment systems. The user may get certain commission amount when the credit collection, from the borrower, is done successfully. The borrower may have to connect to the system 101 for credit payment wherein an account for the borrower is created. The said account is associated with the financial institution/lender. Further, the user may provide the credentials and a reference number to the borrower in order to complete the credit payment. The credit from the borrower may be collected by enabling the borrower to deposit the credit money, either online or offline, to the borrower's account associated with the financial institution/lender. The payment module 213 may further enable the borrower to pay there and then, through the mobile application present on the user device 104 using a variety of payment channels that have already been activated/validated, and often used, by the borrower. The user is therefore largely facilitated as the option to ask the borrower to arrange payment on the spot as opposite to having to accept promises of deferred payments. The user may get a notification on the user device 104 when the credit is successfully collected from the borrower. Further, the commission amount may be reflected and the user can withdraw the earned amount at any time.

The present disclosure provides regular updates on the collection case status/progress. The credit collection procedure can be managed and changed remotely based on the user results and specific needs required by the user or the borrower. Furthermore, the present disclosure provides the legal framework for the users to collect on behalf of the lender or the financial institution. Further, the present disclosure provides a mobile payment option to remit fee earned by the user as-well-as repay the outstanding amount to the lender or the financial institution.

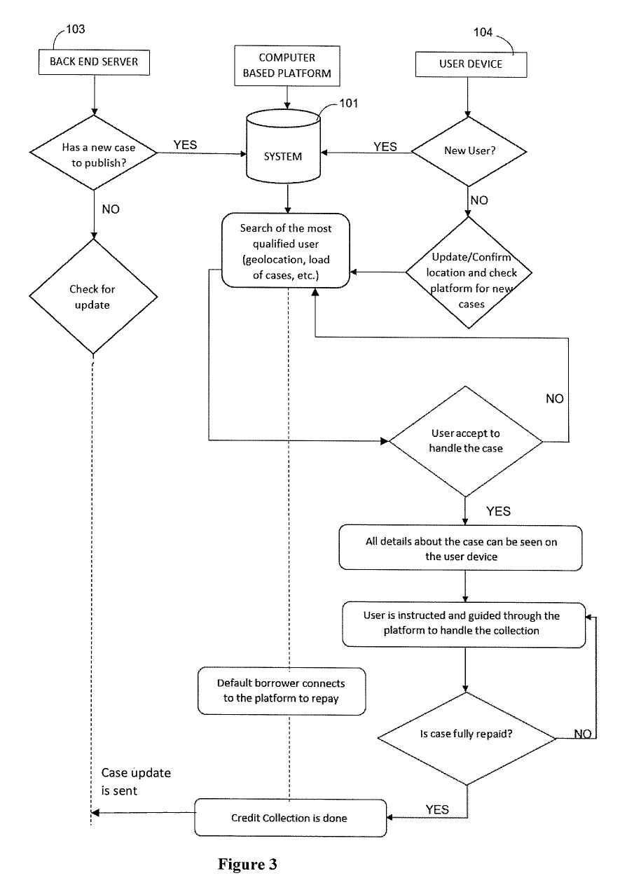

FIG. 3 shows the working of the system 101 along with the modules of the system in accordance with an embodiment of the present disclosure. The system 101, via the credit collection request module 206, may be configured to receive a credit collection request from a back end server 103. The credit collection request may comprise borrower details comprising borrower's geolocation and at least one of the borrower's full name, address, identity proof, outstanding amount, power of attorney and a combination thereof. The borrower's geolocation may be determined using GPS technique by the back end server 103 or by converting, via the location module 207, physical address of the borrower into latitude/longitude coordinates. The system 101 may further be configured to receive a user profile for each user, wherein the user profile comprises the user's geolocation and at least one of the user's name, age, sex, photo and identity proof and a combination thereof. The user's geolocation may be determined by the location module 207 with the help of GPS sensor 203. The system 101, via the training module 208, may be enabled to provide training to each user 104.

Further, the system 101, via the user selection module 209, may be configured to identify one or more registered users, having geolocation within a predefined range of the borrower's geolocation. The system 101, via the user selection module 209, may select a user from one or more registered users based on predefined parameters associated with each user. The predefined parameters comprise at least one of load of credit collection requests assigned to each user, nearest location of each user with respect to the borrower's geolocation, reputation of each user (efficiency of establishing a contact, efficiency of recovering the money quickly, efficiency of working with tiers/party), language, culture and a combination thereof. The system 101, via the user selection module 209, may further be configured to authorize the user to collect the credit due from the borrower based on a predefined credit collection process.

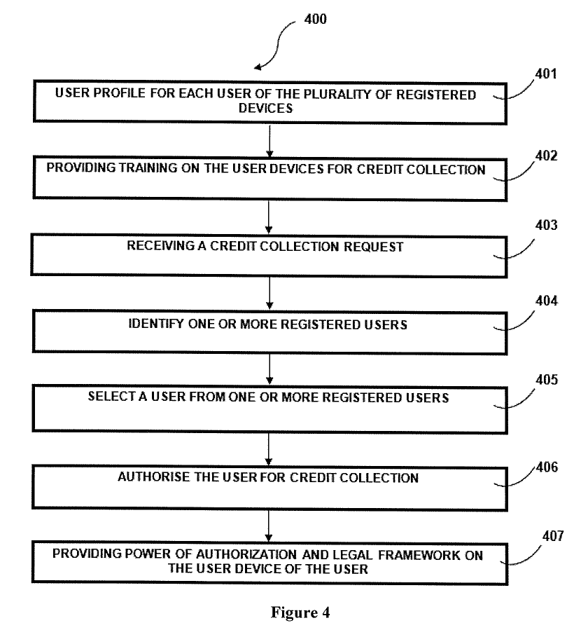

Referring now to FIG. 4, a method 400 of facilitating and enabling the crowdsourced credit collection is shown, in accordance with an embodiment of the present subject matter. The method 400 may be described in the general context of computer executable instructions. Generally, computer executable instructions can include routines, programs, objects, components, data structures, procedures, modules, functions, etc., that perform particular functions or implement particular abstract data types. The method 400 may also be practiced in a distributed computing environment where functions are performed by remote processing devices that are linked through a communications network. In a distributed computing environment, computer executable instructions may be located in both local and remote computer storage media, including memory storage devices.

The order in which the method 400 is described is not intended to be construed as a limitation, and any number of the described methods can be combined in any order to implement the method 400 or alternate methods. Additionally, individuals may be deleted from the method 400 without departing from the spirit and scope of the subject matter described herein. Furthermore, the method can be implemented in any suitable hardware, software, firmware, or combination thereof. However, for ease of explanation, in the embodiments described below, the method 400 may be considered to be implemented in the above described system 101.

At block 401, the user may upload a profile on the system 101 via user device 104. The profile may comprise user's geolocation and at least one of user's name, age, sex, photo, identity proof and a combination thereof. In an embodiment, the geolocation of the user 104 is determined via the GPS sensor 203.

At block 402, each user is trained for the predefined credit collection process via the training module 208 comprising training content associated with the predefined credit collection process.

At block 403, a credit collection request for collecting a credit due from a borrower may be received. The credit collection request may comprise borrower details comprising borrower's geolocation and at least one of borrower's full name, address, identity proof, outstanding amount, power of attorney and a combination thereof. Further, the credit collection request may comprise one or more geographical map tools enabling to navigate to the borrower's location. In one implementation, the credit collection request is received by the credit collection request module 206. The borrower's detail as-well-as the geographical map tools may be stored in the data repository 211.

At block 404, one or more registered users, having a geolocation within a predefined range of the borrower's geolocation may be identified. In one implementation, the one or more registered users may be identified by the location module 207.

At block 405, the method may further comprise selecting, by the processor, a user from one or more registered users based on predefined parameters associated with each user. The predefined parameters comprise at least one of load of credit collection requests assigned to each user, nearest location of each user with respect to the borrower's geolocation, reputation of each user (efficiency of establishing a contact, efficiency of recovering the money quickly, efficiency of working with tiers/party), language, culture and a combination thereof. In one implementation, the user may be selected by the user selection module 209.

At block 406, the user is authorized to collect the credit based on a predefined credit collection process. In one implementation, the user may be authorized to collect the credit by the user selection module 209.

At block 407, a power of authorization and legal framework may be provided on the user device of the user, required for the credit collection.

Although implementations for methods and systems for facilitating and enabling the crowdsourced credit collection have been described in language specific to structural features and/or methods, it is to be understood that the appended claims are not necessarily limited to the specific features or methods described. Rather, the specific features and methods are disclosed as examples of implementations for facilitating the crowdsourced credit collection.

1. A method for facilitating and enabling crowdsourced credit collection on a computer-based platform, the method comprising:
receiving, by a processor, a credit collection request for collecting a credit due from a borrower, wherein the credit collection request comprises borrower details comprising at least a borrower's geolocation;
identifying, by the processor, one or more registered users, having geolocation within a predefined range of the borrower's geolocation;
selecting, by the processor, a user from one or more registered users, wherein the user is selected based on predefined parameters; and
authorizing, by the processor, the user to collect the credit based on a predefined credit collection process.

2. The method of claim 1 further comprising generating a user profile for each user, wherein the user profile comprises the user's geolocation and at least one of the user's name, age, sex, photo, identity proof and a combination thereof.

3. The method of claim 2, wherein each user is trained for the predefined credit collection process using a pre-stored training module comprising training content associated with the predefined credit collection process.

4. The method of claim 1 further comprising displaying, on the user device of the user, the borrower's details and one or more geographical map tools, wherein the borrower's details comprises the borrower's geolocation and at least one of the borrower's full name, address, identity proof, outstanding amount, power of attorney and a combination thereof, and wherein the one or more geographical tools enables navigating to the borrower's geolocation.

5. The method of claim 1, wherein the predefined parameters comprises at least one of load of credit collection requests assigned to each user, nearest location of each user with respect to the borrower's geolocation, reputation of each user, language, culture and a combination thereof.

6. The method of claim 1 further comprising providing, by the processor, a power of authorization and legal framework, on the user device of the user, required for the credit collection.

7. The method of claim 1, wherein the geolocation of the user is determined through a global positioning system (GPS) technique.

8. The method of claim 1, wherein the borrower's geolocation is determined via a global positioning system (GPS) technique or by converting borrower's address to a latitude/longitude coordinates.

9. The method of claim 1 further comprising enabling, by the processor, the borrower to process a payment for the credit using an online or offline payment systems.

10. A system for facilitating and enabling crowdsourced credit collection, the system comprising:
a processor; and
a memory coupled with the processor, wherein the processor is capable of executing programmed instructions stored in the memory for:
receiving a credit collection request for collecting a credit due from a borrower, wherein the credit collection request comprises borrower details comprising at least a borrower's geolocation;
identifying one or more registered users, having geolocation within a predefined range of the borrower's geolocation;
selecting a user from one or more registered users, wherein the user is selected based on predefined parameters; and
authorizing the user to collect the credit from the borrower based on a predefined credit collection process.

11. The system of claim 10, wherein the credit collection request is received from a back-end server, of a creditor, electronically coupled with the system, and wherein the borrower details in the credit collection request further comprises at least one of the borrower's full name, address, identity proof, outstanding amount, power of attorney and a combination thereof.

12. The system of claim 10 further comprising a training module comprising training content associated with the predefined credit collection process, and wherein each user is trained for the predefined credit collection process using the training module.

13. The system of claim 10 further comprising a payment module for
enabling the borrower to process a payment for the credit using an online or offline payment systems; and
remitting the payment, after successful credit collection, earned by the user.

14. The system of claim 10 further comprising a GPS sensor for determining the geolocation of the user via a global positioning system (GPS) technique.

15. A non-transitory computer readable medium storing a program for facilitating and enabling crowdsourced credit collection, the program comprising:
a program code for receiving a credit collection request for collecting a credit due from a borrower, wherein the credit collection request comprises borrower details comprising at least a borrower's geolocation;
a program code for identifying one or more registered users, having geolocation within a predefined range of the borrower's geolocation;
a program code for selecting a user from one or more registered users, wherein the user is selected based on predefined parameters; and
a program code for authorizing the user to collect the credit based on a predefined credit collection process.
